(19) United States
(12) Patent Application Publication
(10) Pub. No.: US 2020/0156089 A1
(43) Pub. Date: May 21, 2020

(54) SPRAY HEAD

(71) Applicant: SNOW LUTIONS INC., Niagara Falls (CA)

(72) Inventors: Gery Hansy Mercnik, Niagara Falls (CA); CYRILLE DESROSIERS, Niagara-On-The-Lake (CA)

(21) Appl. No.: 16/103,558

(22) Filed: Aug. 14, 2018

(51) Int. Cl. B05B 1/18; B05B 15/40

(52) U.S. Cl. CPC B05B 1/185; B05B 15/40

(57) ABSTRACT

This invention relates to a spray head for delivering a fluid having a plurality of passages connecting a plurality of inlets to a plurality of outlets whereby the passages are disposed at selected angles to produce different fluid flow distances from the outlet to define a selected pattern. The selected pattern defines geometric patterns such as a square, rectangle or triangle, whereby the spray patterns of each of the flow distances do not substantially overlap. The spray head has substantially no moving parts and can be formed by computer printing. The invention also relates to a spray head assembly and a method of deicing a surface with deicing or snow melting fluid.

### FIELD OF INVENTION

This invention relates to a spray head for delivering a fluid having a plurality of passages connecting a plurality of inlets to a plurality of outlets whereby the passages are disposed at selected angles to produce different fluid flow distances from the outlet to define a selected pattern. The selected pattern defines geometric patterns such as a square, rectangle or triangle, whereby the spray patterns of each of the flow distances do not substantially overlap. The spray head has substantially no moving parts and can be formed by 3D computer printing. The invention also relates to a spray head assembly and a method of deicing a surface with deicing or snow melting fluid.

### BACKGROUND TO THE INVENTION

Various spray heads and methods of irrigation and deicing have been proposed. Many of these systems attempt to either fertilize land or remove snow and ice in a cost effective manner, preferably by automation, particularly in environments having extremes between the cold and warm season.

Furthermore, there is a desire to spread fluid ice melt in selected patterns such as squares, rectangles or triangles without using moving parts particularly as it relates to the spray heads. Furthermore many prior art devices attempt to minimize slip and falls, or back pain from shovelling or prevent workplace accidents. Many of these devices and applications target parking lots. Slip and falls and vehicle collisions in parking lots are common and a single serious slip and fall event on company property may result in litigation with substantial damages awarded.

There are various pop-up style spray heads, such spray heads fail over time or become jammed with stagnant fluid.

Several prior art devices and methods have been proposed

For example U.S. Pat. No. 4,471,908 relates to a sprinkler of the type adapted to rotate and create a redefined horizontal spray pattern around it. A rotating turbine drives a cylindrical nozzle assembly having a plurality of nozzle openings therein. The nozzle openings deliver streams of water of variable length and volume. A pattern defining disk is used to continuously and proportionately expose the nozzle openings to the source of pressurized water according to a pre-set function of the instantaneous rotational position of the nozzle opening as the cylindrical member turns to create the spray pattern. The nozzle openings supply a relatively constant volume of water to all portions of the pattern.

U.S. Pat. No. 5,360,167 relates to an adjustable arc sprinkler nozzle comprises a nozzle body which has a plurality of radial channels for forming radial streams out of water flowing into the nozzle from a sprinkler body to which the nozzle is joined. A crown shaped deflector member includes a plurality of vertically extending fingers which operatively coact with the radial nozzle channels to restrict the amount of water flowing therethrough. A selectively operable adjusting member is cooperatively engaged with the deflecting member for moving the deflecting member vertically relative to the nozzle body to vary the position of the fingers relative to the channels to change the amount of water restriction imposed by the fingers on the water flowing through the channels, whereby the throw radius is selectively adjusted by vertical movement of the deflecting movement of the deflecting member. A selectively operable locking member, i.e. a locking cover or a two-position locking pin, is provided for preventing movement of the adjusting member to lock out any adjustment in the throw radius

Moreover U.S. Pat. No. 5,630,549 relates to an apparatus is provided for distributing water to a lawn or garden. One or several units may be used to provide for custom watering at any point in the garden. With multiple units stacked, a custom watering pattern may be produced. Each unit has provisions for adjusting the angle of dispersion and the amount of water flow independently of each other.

Moreover U.S. Pat. No. 6,955,304 shows an anti-icing spray assembly designed for airport runways and highways. While U.S. Pat. No. 6,126,083 show a method and stationary arrangement for deicing.

U.S. Pat. No. 6,874,696 shows that the adjustable sprinkler riser includes an outer and an inner telescoping member that telescopically interface with each other. A protrusion is spaced from a proximal end of the outer telescoping member. A first joint member slidably interfaces with the outer telescoping member, and a second joint member slidably interfaces with the inner telescoping member. The second joint member may be selectively secured to the first joint member to restrict movement of the inner telescoping member relative to the outer telescoping member. In such a condition, areas of vulnerability to breakage in the joint members and inner telescoping member are offset from each other to provide greater strength to the adjustable sprinkler riser. In addition, manufacturing the adjustable sprinkler riser is simple because the first and second joint members may be conveniently placed on the telescoping members, and there is no need to form threads or other intricate structures on the telescoping members.

Yet another arrangement is illustrated in U.S. Pat. No. 7,152,514 which shows a sprinkler has a housing with an inlet portion and an outlet portion in which a first outlet aperture is formed. The first outlet aperture may cooperate with other outlet apertures to define a spiral shape. A cam is disposed upstream of the first outlet aperture. The cam is rotatable about a cam axis to cover varying portions of the outlet apertures. After moving through the outlet apertures, water strikes a deflector and is sprayed outward from the head. The orientation of the cam establishes an arc angle through which water is sprayed, including a full-circle spray pattern. The deflector may be stationary or rotatable. In one alternative configuration, the outlet apertures and each leads to a different strip nozzle. The cam has an open portion that can be rotated into alignment with each of the outlet apertures to determine which of the strip nozzles are active.

U.S. Pat. No. 8,833,672 teaches a nozzle and a flow control device for reducing fluid flow through the sprinkler when the nozzle is removed, such as might occur due to vandalism. The flow control device is coupled to the nozzle and is moveable between a first irrigating position and a second signaling position. In the first position, the sprinkler discharges fluid for irrigation. In the second position, the sprinkler discharges a reduced amount of fluid and signals that the nozzle has been removed and should be replaced. The flow control device also allows sufficient fluid flow for flushing debris out of the sprinkler when a flush cap is mounted to the sprinkler, instead of the nozzle.

U.S. Pat. No. 9,174,227 illustrates a nozzle for an irrigation sprinkler is provided, where the nozzle includes a sealing pad for reducing the distance relative to a seal of an irrigation device when the nozzle is in a retracted position to restrict the entry of grit and other debris into the irrigation device

U.S. Pat. No. 9,327,297 shows that a nozzle is provided having a pattern adjustment valve that may be adjusted to irrigate a substantially rectangular irrigation area. The nozzle may be further adjusted to irrigate three different substantially rectangular irrigation areas. The nozzle functions as a three-in-one left strip nozzle, right strip nozzle, and side strip nozzle. The strip irrigation setting may be selected by pressing down and rotating a deflector to directly actuate the valve. The nozzle may also include a flow reduction valve to set the size of the rectangular irrigation areas and may be adjusted by actuation of an outer wall of the nozzle. Rotation of the outer wall causes a flow control member to move axially to or away from an inlet.

Finally US2011/0089250 relates to a nozzle assembly is adapted to generate a specialized rectangular spray in a 3-jet fluidic circuit which generates a substantially planar rectangular spray from a confluence of three jets. The 3-jet geometry circuit has selected floor & taper features configured to create a customizable rectangular or triangular spray pattern. Depending on the throw desired, the nozzle assembly of the present invention can be configured with a second fluidic circuit to generate a flat fan to obtain various aspect ratios in a rectangular spray.

It is an object of this invention to provide an improved automatic spray head.

It is also an object of this invention to provide an improved method of spraying fluid in a desired flow path.

It is a further object of this invention to provide:
(a) simultaneous spray and mist ability;
(b) spray heads that are interchangeable and are adjustable;
(c) nozzles that hook up to regular commercial plumbing and irrigation pumps;
(d) operates under the same pressures as irrigation systems;
(e) operable underneath pavement such as asphalts or the like;
(f) mechanically protected from being driven over by vehicles;
(g) the spray head being actuated by hydraulic pressure.

It is also an object of this invention to provide a spray pattern that has a more efficient coverage by substantially eliminating the need to overlap sections of fluid throw.

### SUMMARY OF INVENTION

It is an aspect of this invention to provide a spray head for delivering a fluid, comprising; a housing defining inlets and outlets; passages connecting said inlets to said outlets, said passage disposed at a selected angles relative said inlets and said outlets mean to produce different fluid flow distances from said outlets to define a selected pattern. In one embodiment the selected pattern defines a geometric pattern, in another embodiment the geometric pattern defines a square, rectangle or triangle

In another embodiment the spray head includes a filter. In yet another embodiment a filter screen retainer is provided to retain said filter screen.

It is another aspect of the invention to provide a plurality of inlets, a plurality of outlets, and a plurality of passages communicating with said plurality of inlets and said plurality of outlets respectively wherein each said inlet and said outlet includes a passage communicating with said respective inlets and outlets, wherein at least two of said passages are selected at different angles to produce different fluid flow distances from said outlet means to define said selected geometric patterns

In yet another embodiment the upper surface of said housing presents a plurality of weight bearing supports. The plurality of weight bearing supports may define a plurality of spaced supports disposed radially outwardly on said upper surface.

It is also an aspect of this invention to provide passages that are formed by additive forming or 3D computer printing.

It is yet another aspect of this invention to provide a spray head assembly for spraying a deicing or snow melting fluid onto a selected surface in a selected pattern comprising: a housing extending along a longitudinal axis and having an upper surface and a lower surface; a spray head presented on said upper surface of said housing, said spray head having a plurality of inlets communicating with a plurality of outlets respectively; a plurality of passages disposed in said spray head communicating with said plurality of inlets and said plurality of outlets respectively, wherein said plurality of passages are selected at different angles to produce different deicing or snow melting fluid flow distances from said plurality of outlets to define said selected geometric patterns.

In one embodiment the plurality of outlets define slots selectively axially disposed relative each other so as to define generally a square, rectangular or triangular pattern. In yet another embodiment the said plurality of outlets define slots that are selectively radially disposed relative each other so as to define generally a square, rectangular or triangular pattern.

Moreover in another embodiment the said plurality of inlets define apertures selectively axially disposed relative each other so as to define generally a square, rectangular or triangular pattern.

The deicing or snow melting fluid comprises KAc.

Furthermore in yet another embodiment the spray head assembly is disposed in or adjacent a roadway.

The spray head can be axially disposed on said upper surface of said housing and further includes a plurality of spaced weight bearing supports disposed radially outwardly from said spray head to the outer portions of said housing.

It is also an aspect of the invention to provide e method of deicing a surface with deicing or snow melting fluid by; selectively positioning a spray head onto said surface said spray head having a plurality of inlets and a plurality of outlets communicating through a plurality of passages respectively; selecting the angle of each said passage to produce different fluid flow distances from said plurality of outlets so that the spray patterns of each said flow distances do not substantially overlap.

In one embodiment the spray head has substantially no moving parts.

It is a further aspect of this invention that the spray head, spray head assembly and method described can be used in warmer climates as an irrigation system whereby the deicing fluid can be substituted for fertilizing fluid.

These and other objects and features of the invention should now be described in relation to the following drawings.

### DESCRIPTION OF THE DRAWINGS

FIG. 1 is a perspective view of the Spray Head

FIG. 2 is a side view of the Spray Head

FIG. 3 is a top view of the Spray Head

FIG. 4 is a Bottom perspective view of the Spray Head

FIG. 5 is a top perspective exploded view of the Spray Head

FIG. 6 is a bottom perspective exploded view of the Spray Head

FIG. 7 Top-view of the Spray Head

FIG. 8 is a cross section view of the side of the Spray head

FIG. 9 is a top view of the Spray Head

FIG. 10 is a bottom view of the Spray Head

FIG. 11 is a side view of the Spray Head

FIG. 12 is a cross section view of FIG. 11

FIG. 13 is a schematic diagram of a typical irrigation setup

FIG. 14 provides a legend for FIG. 13

FIG. 15 is a representative view of a spray pattern

### DETAILED DESCRIPTION

Detailed description of one or more embodiments of the invention is provided below along with the accompanying figure that illustrates the principles of invention. Like parts are given the same number throughout the figure.

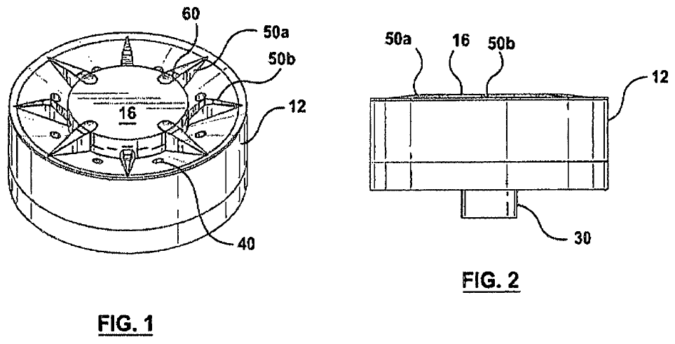

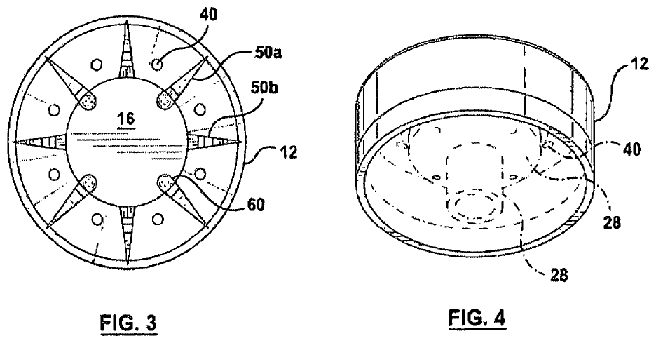

FIGS. 1-4 generally illustrate a spray head assembly 10.

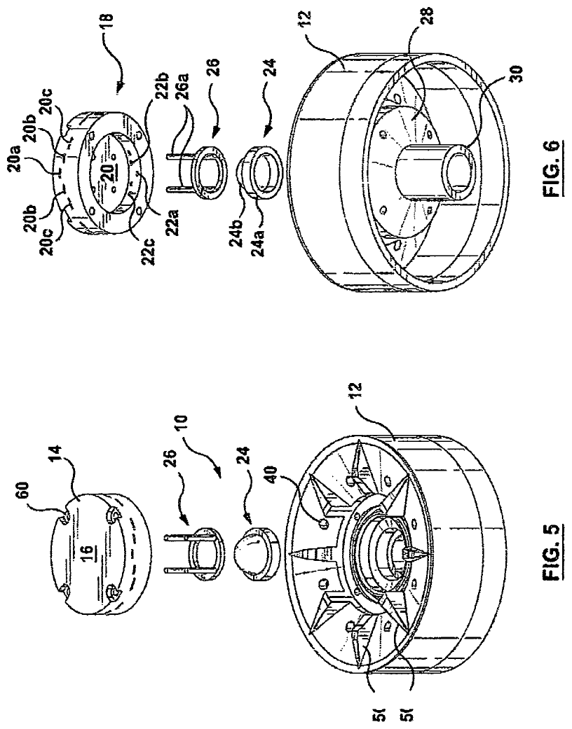

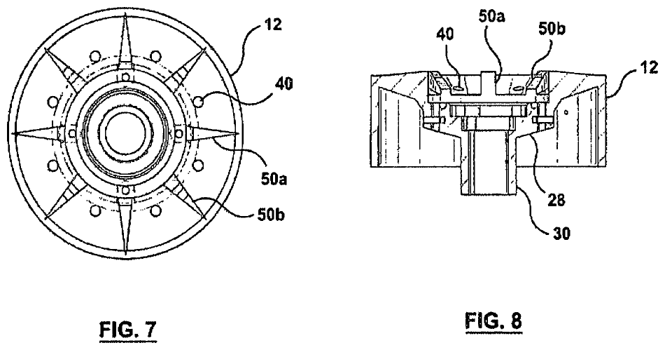

FIGS. 5 and 6 more fully particularize the spray head assembly 10 which illustrates a housing 12 having a spray head 14. The spray head 14 has a top or upper surface 16 and a bottom or tower surface 18 as illustrated. The bottom 18 presents a cavity 20.

The spray head 14 includes apertures or inlets 22 as shown. In particular there are a plurality of apertures or inlets 22a, 22b, and 22c, which are adapted to receive a fluid. The spray head 14 also includes a plurality of outlets 20 disposed around the circumferential upstanding wall of the spray head as shown. In particular, there are a plurality of outlets 20a, 20b, and 20c, as shown.

Each of the plurality of inlets, 22a, 22b, and 22c, communicate with the plurality of outlets 20a, 20b, and 20c, respectively by a plurality of passages 70 as shown in FIG. 12. The passages 70 are selected at a particular angle relative to the inlet 22 and the outlet 20 to produce different fluid flow distances from the outlet 20 to define a selected pattern as more fully particularized below.

In one embodiment the selected pattern design geometric shapes which are selected from a square, rectangle or triangle.

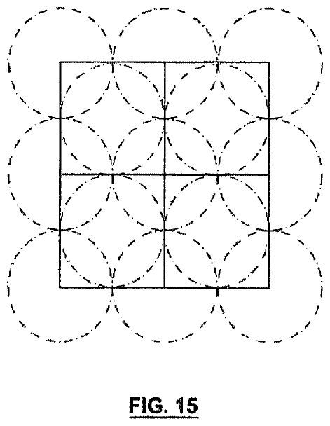

FIG. 15 illustrates the typical circular spray patterns that are found in the prior art which require overlap sections as shown. It is desirable to have a square spay pattern as shown as such spray pattern is more efficient in covering the desired surface by eliminating the need to overlap the sections as shown in FIG. 15. Accordingly, selected geometric shapes or patterns such as the square, rectangle or triangle reduces the amount of wasted fluid as well as reducing the number of spray heads that are needed to cover the same square footage.

More particular, FIG. 15 shows that either in an irrigation or deicing circular pattern spray, unit must be placed apart from each other at a distance equal to the radius of coverage or throw distance. In the example shown in FIG. 15, 13 circular units are needed while only four spray unite are needed when throwing a square pattern that substantially do not overlap.

Furthermore the terms square, rectangular and triangular patterns as utilized herein relate generally to such shapes as the outside perimeter of such square, rectangular or triangular pattern may be Irregular or non-linear.

Accordingly the Invention as shown relates to a spray head 10, 14 delivering a fluid that comprises a housing 12 defining an inlet 22, 30 and an outlet 20. Furthermore the invention disclose passages 70 connecting the inlets 22a, 22b, and 22c to outlets 20a, 20b, and 20c, respectively with passages 70 disposed and selected angles relative to the inlets 22 and outlets 20 to define a selected pattern as for example shown in FIG. 15.

Moreover, the spray head assembly 10 shows the use of a filter 24. The filter 24 includes a generally circular support 24a representing screen material 24b. The screen 24 is retained within a screen retainer 26 having a plurality extensions or legs 26a to space the filter from the bottom surface of the spray head 14.

The housing 12 can include a hub. 28 along the lower surface which also defines an inlet. 30 adapted to receive the deicing fluid directing the deicing fluid towards the plurality of inlets 22a, 22b, and 22c in the spray head 14.

The upper surface of the housing includes a plurality of drain holes 40 to drain any fluid thereunder since the upper surface of the housing 12 is inclined at a slight angle.

The upper surface of the housing also includes weight bearing veins or supports 60a and 50b. The weight bearing veins pr supports 50a are adapted to support the weight of any vehicles or heavy Weight that may come in contact with the spray head assembly 10. The plurality of weight bearing supports 50a and 50b define a plurality of space supports disposed radially outwardly on the upper surface of the housing 12. In particular the weight bearing supports 50a and 56b are disposed radially outwardly from the spray head 14 to the outer portions of the housing 12 so as to distribute the weight to the structure below. The plurality of weight bearing veins or supports 50b are angled in the region adjacent the spray head 14 so as to provide space for the spray patterns of fluid.

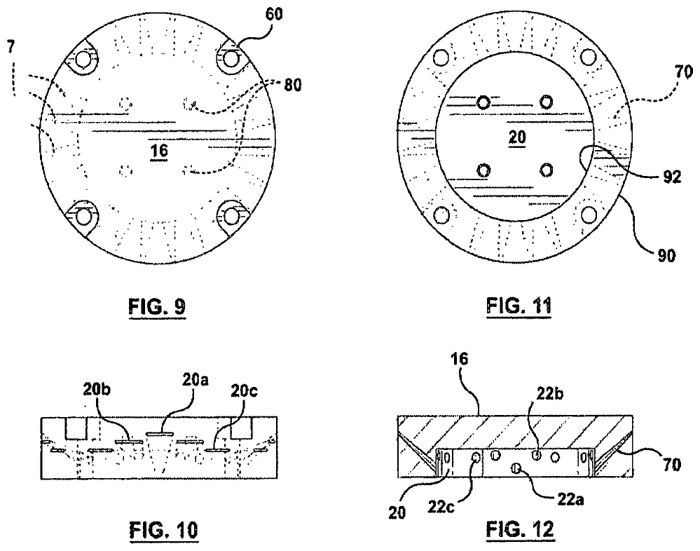

As shown in FIGS. 9, 10, the spray head 14 includes a plurality of holes 80 which permit drainage thereunder and illustrate a circular outer wall 90 and a circular inner wall 92. The passages 70 in spray head 14 can be formed by extrusion or additive forming such as 3D computer printing. The material of the spray head assembly 10 or spray head 14 can comprise plastic or the like.

Furthermore, the invention as described herein relates to a spray head assembly 10 for spraying a deicing or snow melting fluid onto a selected surface in a selected pattern comprising:
(a) a housing 12 extending along a longitudinal axis and having an upper surface and lower surface;
(b) a spray head 14 presented on the upper surface of the housing 12, the spray head 14 having a plurality of inlets 22a, 22b, and 22c, communicating with the plurality of outlets 20a, 20b, and 20c, respectively;
(c) a plurality of passages 70 disposed in the spray head 14 communicating with said plurality of inlets 22 and the plurality of outlets 20 respectively, wherein the plurality of passages 70 are selected at different angles to produce different deicing of snow melting fluid flow distances from the plurality of outlets 20 to define the selected geometric patterns as shown in one embodiment of FIG. 15.

In one embodiment the plurality of outlets 20a, 20b, and 20c define stets selectively actually disposed relative each other as shown in FIG. 12 so as to define generally a square, rectangular or triangular pattern as described.

Furthermore the plurality of outlets 20a, 20b, and 20c, define slots that are selectively radially disposed relative each other so as to define generally a square, rectangular or triangular pattern. The selected generally square, rectangular or triangular patterns are produced by replacing the spray head 14 with other spray head 14 that individually produce one of the generally square, rectangular or triangular pattern of spray.

In one embodiment the spray head assembly 10 is disposed either in or adjacent a roadway.

Furthermore the spray head assembly 10 can have a spray head 14 that is actually disposed on the upper surface of the housing 12 and further includes a plurality of spaced weight bearing supports 50a and 50b, disposed radially outwardly from the spray head 14 to the other portions of the housing.

The invention as described herein also relates to a method of deicing a surface with deicing or snow melt fluid by:
(a) selectively positioning a spray head 14 onto a surface where the spray head 14 has a plurality of inlets 22 and a plurality of outlets 20 communicating through a plurality of passages 70 respectively;
(b) selecting the angle of each passage 70 to produce different fluid flow distances from the plurality of outlets 20 so that the spray patterns of each of the flow distances do not substantially overlap.

The deicing or snow removal fluid can comprise of any number of fluids including potassium acetate, sodium chloride, magnesium chloride calcium chloride, calcium magnesium acetate, or the like.

In one embodiment a 50% saturation of potassium acetate With water is effective as compared to some more corrosive alternatives such as calcium chloride or magnesium chloride although the invention as described herein can utilize such fluids. However chloride based ice Melting fluid tend to be corrosive to the concrete and rebar as well contaminate local bodies of water.

In one application a third of a gallon of potassium acetate can be used per 1,000 square feet. Pre-wetting can be utilized where pre-wetting is a process of preparing the surface for ice formation and therefor preventing the bond between ice crystals and asphalt or concrete. The invention as described herein is especially useful during the pre-wetting stage and after the snow and Ice start accumulating. The spray heads 14, 10 as described herein can periodically deposit ice melt thereby preventing further bonding between the Ice and ground and causing existing snow and ice to melt even below freezing temperatures.

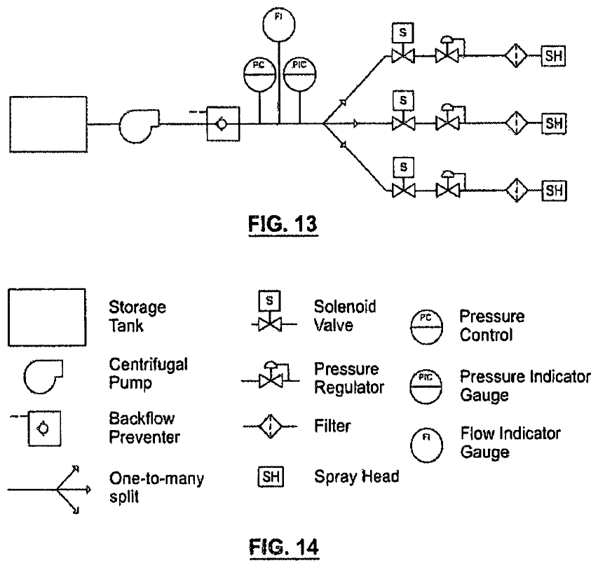

FIGS. 13 and 14 are schematic views of an example of typical systems that can be utilized as well as a legend that is shown in FIG. 14 in relation to FIG. 13.

The slits of the outlets 20 can produce either a mist or a spray and can be selected to be wider or thinner or with a deeper or shallower interior angle 70 to produce different throw distances and fluid patterns on a surface.

By varying the angle of passages 70 one achieves spray patterns which are substantially selected to be rectangular, square, or triangular.

In general, in the following claims, the terms used should not be construed to limit the invention to the specific embodiments disclosed in the specification and the claims, but should be construed to include all possible embodiments along with the full scope of embodiments to which said claims are entitled. Accordingly the invention is not limited to the disclosure, but rather instead its scope is to be determined by the following claims.

1. A spray head for delivering a fluid, comprising:
(a) a housing defining an inlet means and an outlet means;
(b) passage means connecting said inlet means to said outlet means, said passage means disposed at a selected angle relative said Inlet means and said outlet means to produce different fluid flow distances from said outlet means to define a selected pattern

2. A spray head as claimed in claim 1 wherein said selected pattern defines a geometric pattern.

3. A spray head as claimed in claim 2 wherein said geometric pattern is selected from a square, rectangle or triangle

4. A spray head as claimed in claim 3 further including a filter between said inlet means and said outlet means.

5. A spray head as claimed in claim 4 further including a filter screen retainer to retain said filter screen.

6. A spray head as claimed in claim 5 wherein said inlet means comprises a plurality of inlets, and said outlet means comprises a plurality of outlets, and a plurality of passages communicating with said plurality of inlets and said plurality of outlets respectively wherein each said inlet and said outlet includes a passage communicating with said respective inlets and outlets, wherein at least two of said passages are selected at different angles to produce different fluid flow distances from said outlet means to define said selected geometric patterns

7. A spray head as claimed in claim 6 wherein said upper surface of said housing a plurality of weight bearing supports.

8. A spray head as claimed in claim 7 wherein said plurality of weight bearing supports define a plurality of spaced supports disposed radially outwardly on said upper surface.

9. A spray head as claimed in claim 8 wherein said passages are formed by additive forming or extrusion.

10. A spray head as claimed by claim 9 wherein said additive forming comprises computer printing.

11. A spray head as claimed in claim 1 wherein said spray head comprises thermoplastic material, polyethylene, metal, steel, aluminum or brass.

12. A spray head assembly for spraying a deicing or snow melting fluid or water and/or nutrient onto a selected surface in a selected pattern comprising:
(a) a housing extending along a longitudinal axis and having an upper surface and a lower surface
(b) a spray head presented on said upper surface of said housing, said spray head having a plurality of inlets communicating with a plurality of outlets respectively;
(c) a plurality of passages disposed in said spray head communicating with said plurality of inlets and said plurality of outlets respectively, wherein said plurality of passages are selected at different angles to produce different deicing or snow melting or water and/or nutrient fluid flow distances from said plurality of outlets to define said selected geometric patterns.

13. A spray head assembly as claimed in claim 12 wherein said plurality of outlets define slots selectively axially disposed relative each other so as to define generally a square, rectangular or triangular pattern.

14. A spray head assembly as claimed in claim 13 wherein said plurality of outlets define slots are selectively radially disposed relative each other so as to define generally a square, rectangular or triangular pattern.

15. A spray head assembly as claimed in claim 14 wherein said plurality of inlets define apertures selectively axially disposed relative each other so as to define generally a square, rectangular or triangular pattern.

16. A spray head as claimed in claim 15 wherein said deicing or snow melting fluid comprises KAc.

17. A spray head assembly as claimed in claim 16 wherein said spray head assembly is disposed in or adjacent a roadway.

18. A spray head assembly as claimed in claim 17 wherein said spray head is axially disposed on said upper surface of said housing and further including a plurality of spaced weight bearing supports disposed radially outwardly from said spray head to the outer portions of said housing.

19. A method of deicing a surface with deicing or snow melting fluid by:
(a) selectively positioning a spray head onto said surface said spray head having a plurality of inlets and a plurality of outlets communicating through a plurality of passages respectively;
(b) selecting the angle of each said passage to produce different fluid flow distances from said plurality of outlets so that the spray patterns of each said flow distances do not substantially overlap.

20. A method of deicing a surface with deicing or snow melting fluid as claimed in claim 19 where said spray head has substantially no moving parts.

21. A method of deicing a surface with deicing or snow melting fluid as claimed in claim 20 wherein said spray head is formed by computer 3D printing.

22. A method of watering and adding nutrients to a surface by:
(a) selectively positioning a spray head onto said surface said spray head having a plurality of inlets and a plurality of outlets communicating through a plurality of passages respectively;
(b) selecting the angle of each said passage to produce different fluid flow distances from said plurality of outlets so that the spray patterns of each said flow distances do not substantially overlap.
